(19) United States
(12) Patent Application Publication
(10) Pub. No.: US 2025/0017814 A1
(43) Pub. Date: Jan. 16, 2025

(54) Telescopic Machine Core

(71) Applicant: Dongguan Mengqu Electronic Technology Co., Ltd, Dongguan City (CN)

(72) Inventor: Jinqiang LI, Dongguan City (CN)

(21) Appl. No.: 18/222,316

(22) Filed: Jul. 14, 2023

(51) Int. Cl. A61H 19/00

(52) U.S. Cl. CPC A61H 19/44; A61H 2201/0192; A61H 2201/1215; A61H 2201/149

(57) ABSTRACT

A telescopic machine core, may include a shell, a sliding wheel disc a bracket, wherein the top of the shell is bolted with the motor, the output shaft of the motor is connected with the reciprocating screw rod through the coupling, the reciprocating screw rod is provided with two symmetrical spiral grooves, the inner cavity of the spiral groove is slidably connected with the driving block, the spiral groove of the reciprocating screw rod drives the sliding wheel disc through the driving block, the top of the reciprocating screw rod penetrate through the bracket and is connected with two eccentric wheels by key connection, both sides of the top of the bracket are integrally formed with the fixing bracket, and the opposite side of the fixing bracket is rotatably connected with the head supporting shaft.

### FIELD OF THE INVENTION

The invention relates to the technical field of machine cores, in particular to the telescopic machine core.

### BACKGROUND OF THE INVENTION

The machine core is the important part of mechanical equipment. The main function is to convert the power of the motor into the power needed by the equipment, which could change the direction and size of the motor power and is applied to many equipment.

In some fields of equipment, the machine core is necessary, such as the massage stick used for health care, etc. The existing massage stick generally only has the vibration function, and the movement mode is single, which could not bring users the fully satisfying experience.

### SUMMARY OF THE DISCLOSURE

The purpose of the present invention is to provide a telescopic machine core, which could drive the sliding wheel to move up and down, so that massage beads could achieve the function of messaging, and simultaneously drive the vibrating head to swing, which could enhance the multi-directional touch sensation of the user and improve the massage experience, in order to solve the problems mentioned in the background of the invention.

In order to achieve the above purpose, the present invention provides the following technical solutions:

A telescopic machine core comprises the shell, the sliding wheel disc and the bracket, wherein the top of the shell is bolted with the motor, the output shaft of the motor is connected with the reciprocating screw rod through the coupling, two symmetrical spiral grooves are arranged on the reciprocating screw rod, the inner cavity of the spiral groove is slidably connected with the driving block, the spiral groove of the reciprocating screw rod drives the sliding wheel disc through the driving block, the top of the reciprocating screw rod penetrates through the bracket and is connected with two eccentric wheels by key connection, both sides of the top of the bracket are integrally formed with the fixing bracket, the opposite side of the fixing bracket is rotatably connected with the head supporting shaft, and the top of the head supporting shaft is in contact with the vibrating head, the bottom of the vibrating head is provided with the guiding groove matched with the eccentric wheels.

Preferably, the periphery of the bottom of the bracket is clamped with the guiding rod, the top of the sliding wheel disc is provided with the through groove which is matched with the guiding rod, the bottom of the guiding rod penetrates through the through groove and is clamped with the fixing plate, the bottom of the fixing plate is bolted with the top of the motor.

Preferably, the number of guiding rods is at least four, and the center of the top of the sliding wheel disc is provided with the cavity matched with the reciprocating screw rod.

Preferably, the outer side of the inner cavity of the sliding wheel disc is fixedly connected with the rotating shaft, the surface of the rotating shaft is sleeved with the plurality of massage beads and the surface of the sliding wheel disc is axially provided with grooves for installing the massage beads. Preferably, the number of massage beads is at least six.

Compared with the prior art, the invention has the following beneficial effects:

The invention provides a telescopic machine core, which could drive the sliding wheel disc to move up and down through the cooperation of the motor, the reciprocating screw rod, the spiral groove, the driving block, the sliding wheel disc, the massage bead, the eccentric wheel, the bracket and the vibrating head, so that the massage beads could achieve the function of messaging, and simultaneously drive the vibrating head to swing left and right, thereby enhancing the multi-directional touch sensation of the user and improving the massage experience.

### BRIEF DESCRIPTION OF THE DRAWINGS

FIG. 1 is the perspective view of the overall structure of the present invention.

FIG. 2 is the perspective view of the motor, the eccentric wheel, the reciprocating screw rod, the sliding wheel disc and the fixing bracket of the present invention.

FIG. 3 is the perspective view of the vibrating head, the eccentric wheel, the reciprocating screw rod and the sliding disc of the present invention.

### DETAILED DESCRIPTION OF THE PREFERRED EMBODIMENTS

Other features, objects and advantages of the present invention will become more apparent through the detailed description of the non-limiting embodiments with reference to the following drawings. It is obvious to those skilled in this field that the description following refers to the particular embodiments of the present invention, this invention is not limited to the details of the following mentioned embodiments, but could be realized in other specific implementation without departing from the spirit or essential characteristics of this invention.

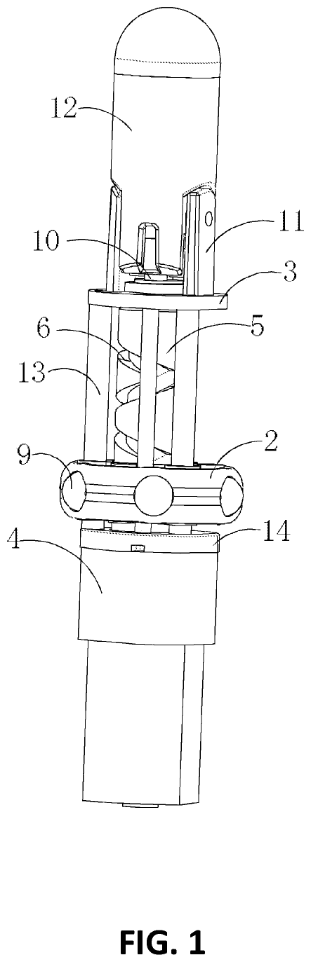

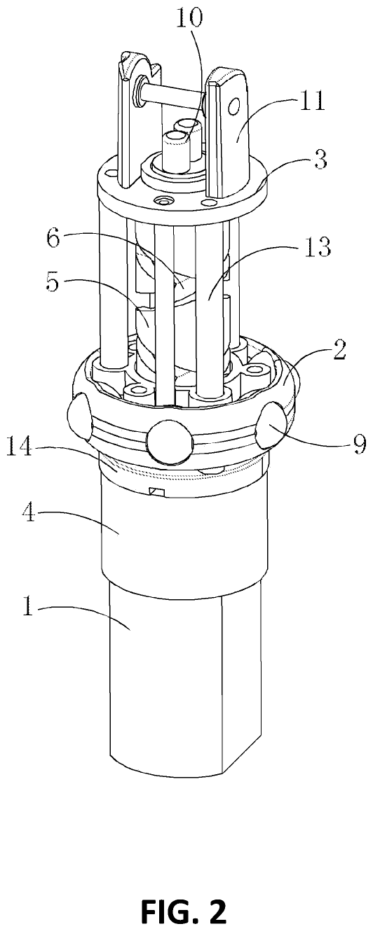

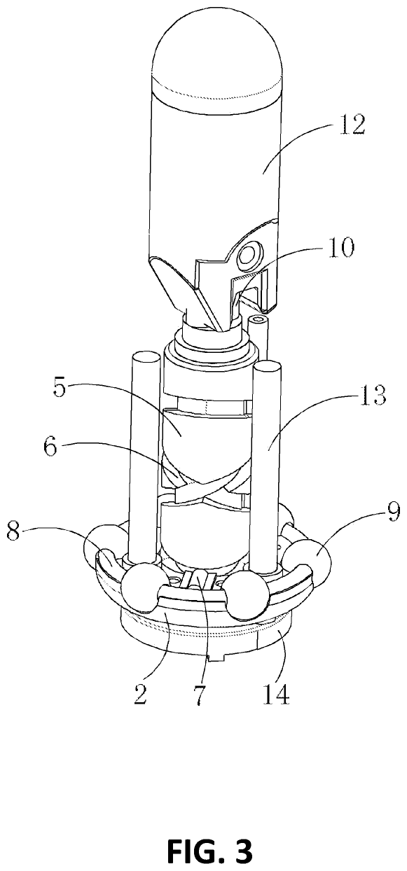

The invention provides a telescopic machine core as shown in FIGS. 1 to 3, which comprises the shell 1, the sliding wheel disc 2 and the bracket 3, wherein the top of the shell 1 is bolted with the motor 4, the output shaft of the motor 4 is connected with the reciprocating screw rod 5 through the coupling, two symmetrical spiral grooves 6 are arranged on the reciprocating screw rod 5, the inner cavity of the spiral groove 6 is slidably connected with the driving block 7, the spiral groove 6 of the reciprocating screw rod 5 drives the sliding wheel disc 2 through the driving block 7, the top of the reciprocating screw rod 5 penetrates through the bracket 3 and is connected with two eccentric wheels 10 by key connection, both sides of the top of the bracket 3 are integrally formed with the fixing bracket 11, the opposite side of the fixing bracket 11 is rotatably connected with the head supporting shaft, and the top of the head supporting shaft is in contact with the vibrating head 12, the bottom of the vibrating head 12 is provided with the guiding groove matched with the eccentric wheels 10. During use, the motor 4 drives the reciprocating screw rod 5 to rotate, under the action of the spiral groove 6, the driving block 7 is driven to move up and down, then the driving block 7 drives the sliding wheel disc 2 to move up and down, and the sliding wheel disc 2 drives the massage beads 9 to move up and down for massaging. At the same time, the reciprocating screw rod 5 drives the eccentric wheel 10 to pull the vibrating head 12, which is horizontally fixed under the action of the head support shaft and swings left and right. The above actions could enhance the multi-directional touch sensation of users and improve the massage effect.

The periphery of the bottom of the bracket 3 is clamped with the guiding rod 13, the top of the sliding wheel disc 2 is provided with the through groove which is matched with the guiding rod 13, the bottom of the guiding rod 13 penetrates through the through groove and is clamped with the fixing plate 14, the bottom of the fixing plate 14 is bolted with the top of the motor 4, which plays the role in guiding and limiting the sliding wheel disc 2, assisting the sliding wheel disc 2 to move up and down, and improving the stability of the sliding wheel disc 2.

The number of guiding rods 13 is at least four, and the center of the top of the sliding wheel disc 2 is provided with the cavity matched with the reciprocating screw rod 5, thus improving the stability of the sliding wheel disc 2. The outer side of the inner cavity of the sliding wheel disc 2 is fixedly connected with the rotating shaft 8, the surface of the rotating shaft 8 is sleeved with the plurality of massage beads 9, and the surface of the sliding wheel disc 2 is axially provided with grooves for installing the massage beads 9, so that the human body could be massaged by the massage beads 9.

The number of massage beads 9 is at least six, the massage effect could be improved with the increasing number of massage beads 9.

Hereinafter, embodiments of the present invention has been described in detail with reference to the accompanying drawings. While the description above refers to the particular embodiments of the present invention, it will be understood that many modifications may be made without departing from the spirit thereof. Any equivalent replacement or modification would fall within the protection scope of the present invention.

What is claimed is:

1. A telescopic machine core comprises a shell (1), a sliding wheel disc (2) and a bracket (3), which is characterized in that the top of the shell (1) is bolted with a motor (4), the output shaft of the motor (4) is connected with a reciprocating screw rod (5) through the coupling, two symmetrical spiral grooves (6) are arranged on the reciprocating screw rod (5), the inner cavity of the spiral groove (6) is slidably connected with a driving block (7), the spiral groove (6) of the reciprocating screw rod (5) drives the sliding wheel disc (2) through the driving block (7), the top of the reciprocating screw rod (5) penetrates through the bracket (3) and is connected with two eccentric wheels (10) by key connection, both sides of the top of the bracket (3) are integrally formed with a fixing bracket (11), the opposite side of the fixing bracket (11) is rotatably connected with the head supporting shaft, and the top of the head supporting shaft is in contact with a vibrating head (12), the bottom of the vibrating head (12) is provided with the guiding groove matched with the eccentric wheels (10).

2. A telescopic machine core according to claim 1, is characterized in that the periphery of the bottom of the bracket (3) is clamped with the guiding rod (13), the top of the sliding wheel disc (2) is provided with the through groove which is matched with the guiding rod (13), the bottom of the guiding rod (13) penetrates through the through groove and is clamped with the fixing plate (14), the bottom of the fixing plate (14) is bolted with the top of the motor (4).

3. A telescopic machine core according to claim 2, is characterized in that the number of guiding rods (13) is at least four, and the center of the top of the sliding wheel disc (2) is provided with the cavity matched with the reciprocating screw rod (5).

4. A telescopic machine core according to claim 1, is characterized in that the outer side of the inner cavity of the sliding wheel disc (2) is fixedly connected with the rotating shaft (8), the surface of the rotating shaft (8) is sleeved with the plurality of massage beads (9), and the surface of the sliding wheel disc (2) is axially provided with grooves for installing the massage beads (9).

5. A telescopic machine core according to claim 4, is characterized in that the number of massage beads (9) is at least six.
